(19) United States
(12) Patent Application Publication
(10) Pub. No.: US 2022/0145858 A1
(43) Pub. Date: May 12, 2022

(54) KINETIC TURBINE GENERATOR

(71) Applicant: Craig Curtis Corcoran, Kansas City, MO (US)

(72) Inventor: Craig Curtis Corcoran, Kansas City, MO (US)

(21) Appl. No.: 17/522,766

(22) Filed: Nov. 9, 2021

Related U.S. Application Data
(60) Provisional application No. 63/112,317, filed on Nov. 11, 2020.

(51) Int. Cl. F03D 9/25; H02K 7/18; F03D 9/28

(52) U.S. Cl. CPC F03D 9/25; F05B 2220/706; F03D 9/28; H02K 7/1823

(57) ABSTRACT

One embodiment of a power-generation system includes a convergent-divergent (“con-di”) nozzle, a compressor coupled to the con-di nozzle and adapted to motivate a flow of gas to exit the con-di nozzle, and a kinetic turbine situated to be excited by the flow of gas exiting the turbine, thereby enabling a generation of power from the excitation of the turbine. A method of power generation includes directing a flow of gas through a convergent-divergent nozzle at a speed greater than the speed of sound and causing a turbine to rotate in response to the flow of gas, thereby generating power from the rotating turbine.

### CROSS-REFERENCE TO RELATED APPLICATION

This application claims benefit to provisional application No. 63/112,317, filed on Nov. 11, 2020, which is incorporated by reference herein.

### BACKGROUND

The field on invention relates to power generation, such as the generation of electrical or motive power. Common methods of generating power include utilizing steam-cycle turbines powered with heat energy derived from resources such as fission, geothermal, solar, natural-gas, coal, hydrogen, petroleum, wood, and biomass. Other methods of generating power include hydroelectric, solar photovoltaic, wind turbines, and devices harnessing energy from waves, tides, and other ocean movements. Even though wind turbines utilize the power of a kinetic air flow, there effectiveness is limited by natural wind availability and low air speeds. An improved and useful method of generating power is desirable.

### SUMMARY

A system for generating power is provided. One embodiment of the system includes a convergent-divergent (“con-di”) nozzle, a compressor coupled to the con-di nozzle and adapted to motivate a flow of gas through the con-di nozzle, and a kinetic turbine situated to be excited by the flow of gas exiting the con-di nozzle, thereby enabling a generation of power from the excitation of the turbine. A method of power generation includes directing a flow of gas through a convergent-divergent nozzle at a speed greater than the speed of sound and causing a turbine to rotate in response to the flow of gas, thereby generating power from the rotating turbine.

### BRIEF DESCRIPTION OF THE DRAWINGS

FIGS. 1 and 1A depict illustrative con-di nozzles suitable for use in accordance with an embodiment of the present invention;

FIG. 2 is a high-level diagram of a compressor suitable for use in accordance with an embodiment of the present invention;

FIG. 3 is a high-level diagram of a kinetic turbine suitable for use in accordance with an embodiment of the present invention;

FIG. 3A depicts an illustrative set of turbine blades according to an embodiment of the present invention;

FIG. 4 is an exploded view of components that make up an embodiment of the present invention;

FIG. 5 is a power-generation apparatus in accordance with an embodiment of the present invention;

FIG. 6 is a power-generation method in accordance with an embodiment of the present invention; and

FIG. 7 depicts another illustrative operative environment suitable for practicing an embodiment of the invention.

### DETAILED DESCRIPTION

An embodiment of the disclosed invention relates to the generation of power by accelerating a flow of pressurized fluid through a “con-di” nozzle. A con-di nozzle is in the shape of tube that narrows in the middle. Con-di nozzles are known in the art and known by other names, such as “a convergent-divergent nozzle,” a “de Laval nozzle,” a “CD nozzle.” A con-di nozzle is characterized by having an hourglass-type shape that accelerates a pressurized gas through it to supersonic speed in an axial (thrust) direction by converting the energy of the flow into kinetic energy. Thus, all references herein (including in the claims) refer to a “con-di” nozzle, the type of known nozzle that is specifically shaped and designed to facilitate an egress of compressible fluid at supersonic speeds. Those skilled in the art understand how to make and use con-di nozzles.

As used herein, “fluid” includes air and gasses. Similarly, reference to “air” herein includes air, gases, and other types of compressible fluids (e.g., compressible gas and liquid mixtures).

In one embodiment, the invention utilizes a con-di nozzle to excite air to supersonic speeds to drive a kinetic turbine responsive to the kinetic air flow. Electricity is generated by accelerating a flow of pressurized air supplied by, for example, an air compressor through a con-di nozzle to drive a kinetic turbine generator from the supersonic kinetic airflow. An air compressor can be provided with an air intake and an air outlet. The air compressor is a device that increases the pressure of air with respect to its surroundings. The air compressor generally relies on reducing the volume occupied by a quantity of air, increasing the quantity (e.g., mass) of air within a given volume, or a combination thereof.

The air compressor produces sufficient air pressure and outlet air velocity to make use of the con-di nozzle to accelerate air flow to Mach 1 at the constriction of the con-di nozzle so as to facilitate exciting the air to supersonic speeds through the divergent portion of the nozzle. A kinetic turbine, adapted to respond to the egress air flow, generates motive power. One embodiment includes a turbine generator responsive to a kinetic air flow to make use of the resulting air flow to generate electricity.

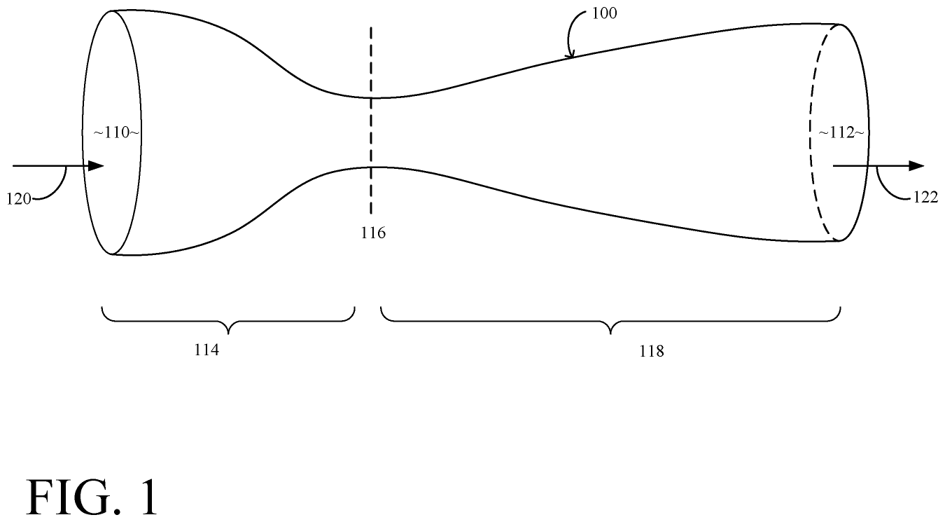

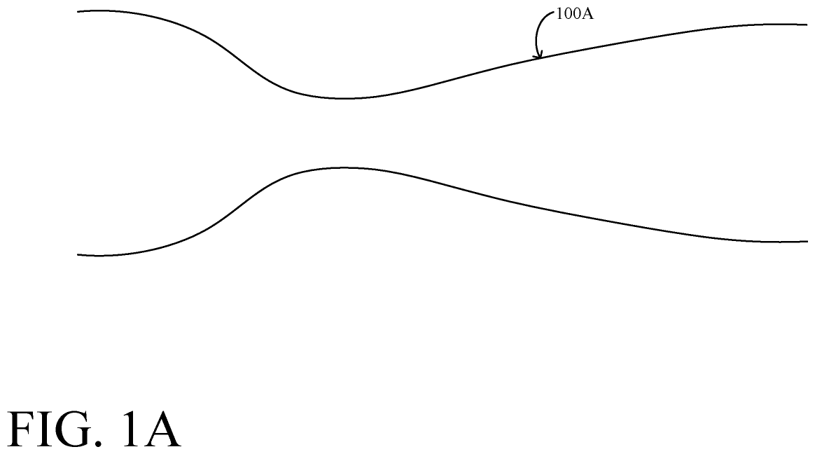

FIG. 1 depicts an illustrative con-di nozzle (variously referred to herein as “CD Nozzle” or just “nozzle” given that the nozzle of all embodiments is a CD Nozzle) suitable for operation in an embodiment of the present invention and referenced generally by the numeral 100. CD nozzle 100 includes an inlet 110 and outlet 112. CD Nozzle 100 includes an ingress (or constriction) portion 114, a throat 116 (located at the smallest diameter of the nozzle), and an egress (or divergent/diverging) portion 118.

The contour of nozzle 100 is not meant to be limiting except to the extent it is characterized by a con-di nozzle as is known in the art. Con-di nozzles can vary somewhat but have known attributes. For example, gas flow through a con-di nozzle is isentropic (gas entropy is nearly constant). At throat 116, where the cross-sectional area is at its minimum, the gas velocity becomes sonic (Mach 1), creating a condition called “choked flow.” As gas exits throat 116, the increase in area enables it to undergo a Joule-Thompson expansion such that the gas expands at supersonic speeds from high to low pressure pushing the velocity of the mass flow beyond sonic speed. These concepts are explained in, for example, the Wikipedia entry for “de Laval nozzle” (e.g., en.wikipedia.org/wiki/De_Laval_nozzle), a copy of which is included in an Information Disclosure Statement filed herewith. Thus, other nozzles that are not such con-di nozzles are not considered prior art and are considered beyond the scope of the claims. Conversely, the nozzle mentioned in the claims herein is of the sort mentioned and utilizes the super-sonic operating conditions mentioned in the aforementioned article, which are known in the art (as evidenced by their description in the illustrative article).

Arrow 120 indicates that air flows into inlet 110, through ingress portion 114, through the throat 116, through divergent portion 118, and exits through outlet 112, as indicated by arrow 122.

FIG. 1A depicts a simplified representation of nozzle 100, referenced by numeral 100A. References to “100” and “100A” are interchangeable herein.

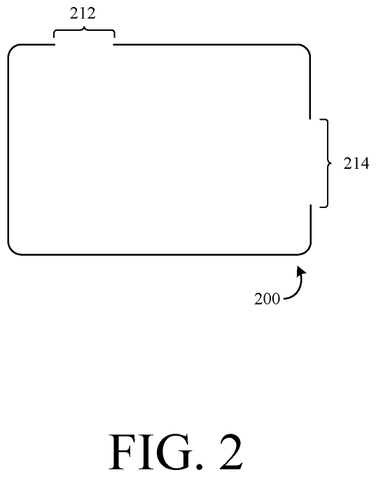

FIG. 2 depicts an air compressor 200. Air compressor 200 could take a variety of forms. For example, it might be a large commercial air compressor with one or more inlet ports 212 and one or more egress ports 214. Air compressor 200 compresses air to such a degree that it enables the operating conditions of the claimed invention. For example, compressor 200 compresses air such that it releases air into a con-di nozzle such that the air speed entering the nozzle throat is Mach 1 and, given the characteristics of a con-di nozzle, the air speed then proceeds from the throat at speeds greater than Mach 1.

Air compressor 200 could be any air or gas compressor that generally relies on reducing the volume occupied by a quantity of air, increasing the quantity (e.g., mass) of air within a given volume, or a combination thereof. Even though such processes may increase the temperature of the air of gas, air compressors, for purposes herein, compressor 200 does not include devices that rely primarily on the input of heat energy to raise the pressure of air.

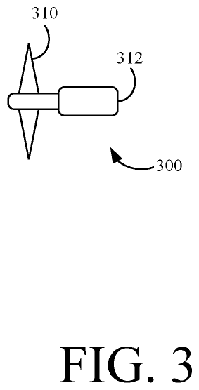

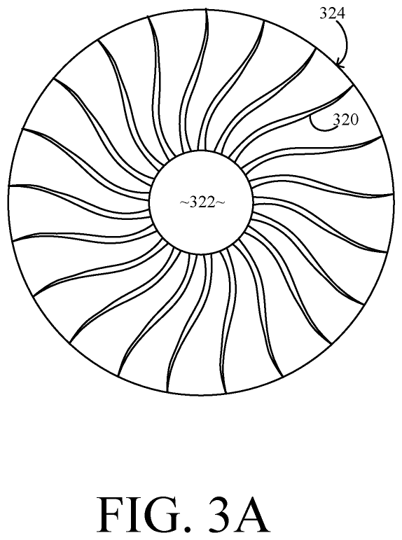

FIG. 3 depicts an illustrative turbine 300. In one embodiment, turbine 300 includes an electricity-generating generator 312 and a set of fins (or blades) 310. Turbine 300 is a kinetic turbine and excludes devices that rely primarily on pressure differentials across the turbine to rotate it. Turbine 300 otherwise includes any motive power device or means that generates power in response to a kinetic flow of air. The air flow strikes the turbine blades or other means such that a portion of the kinetic energy excites the rotational movement of the turbine itself. Conservation of mass provides that the amount of air or gas entering the turbine is the same as the amount exiting the turbine (although there might be a small difference due to practical applications and non-conservative forces, e.g., due to friction). Betz's law gives the maximum achievable extraction of air flow power by a kinetic turbine as 16/27 of the rate at which the kinetic energy of the air or gas arrives at the turbine.

During the flow process within the con-di nozzle related to the acceleration of air or gas to supersonic speeds, pressure decreases between the ingress and egress of the nozzle, such that the pressure of the air or gas exiting the con-di nozzle may be approximately equal to, less than, or greater than that of the ambient environment, with efficient operations somewhat dependent on pressure approximately equal to ambient. Even though the kinetic air flow in this device is originally excited by pressure supplied by the air or gas compressor, as well as the drop in pressure within the con-di nozzle, once the air or gas reaches the egress of the divergent portion of the con-di nozzle, the kinetic energy of the air or gas flow will no longer be primarily dependent on a pressure differential between the pressure of such air or gas flow and the ambient environment. Rather, it will primarily be a function of the developed velocity of such air or gas flow—hence the energy developed for use by the kinetic turbine as referenced herein as kinetic.

Turbine 300 could be a single stage or multistage turbine, with a single set of blades or multiple sets. Other devices, some of which may be considered bladeless, also exist that make use of kinetic air flows. For purposes herein, kinetic turbines include any device or means that are excited by the kinetic flow of air or gas, including but not limited to devices akin to wind turbines. However, whereas most wind turbines are built to withstand only moderate air speeds, this invention contemplates extracting energy from supersonic air speeds. Therefore, some embodiments of kinetic turbines for use herein will include support structures and a housing to support the structural integrity of the turbines themselves and be of a smaller diameter compared to large wind turbine blades.

FIG. 3A depicts an illustrative set of turbine blades (one of which is denoted as 320) supported at their interior to an axle 322 and supported at the exterior by an outer supporting ring 324. Blades 320 are shown in an illustrative, not limiting, fashion. There may be fewer or more. Blades 320 could be sized or shaped differently. Ring 324 helps prevent the blades from being structurally compromised by the high-speed air flowing through them. In one embodiment, ring 324 is situated within at least a portion of the structure of the device so as to allow for rotational movement of ring 324, while limiting translational movement, like a bearing.

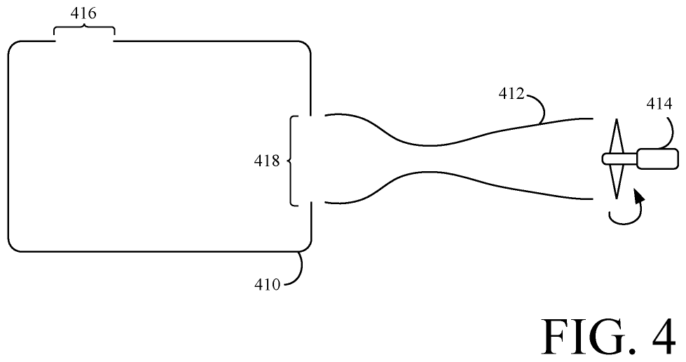

FIG. 4 depicts an exploded view of aspects of an embodiment of the invention. The drawing is not to scale. Rather, it is intended to illustrate certain functional aspects of an embodiment of the invention. FIG. 4 shows an illustrative air compressor 410, con-di nozzle 412, and turbine 414. The spatial gaps represented the exploded aspect of the drawing. There would not be such physical gaps. FIG. 4 illustrates that many versions of a compressor 410 could be used to motivate an airflow through nozzle 412 to excite turbine 414, and thereby generate electricity.

In the embodiment of FIG. 4, a source of a gaseous flow in the form of an air compressor 410 is provided with an air intake 416 and an air outlet 418. A convergent-divergent shape in the form of a con-di nozzle 412 is disposed to receive the kinetic air flow from the air outlet 418 of compressor 410. A motive power source in the form of a turbine generator 414 responsive to a kinetic air flow is disposed within the path of the air flow passing through con-di nozzle 412.

The compressed air is directed through con-di nozzle 412 to increase the kinetic energy of the air flow. In this embodiment, air compressor 410 is adapted to produce sufficient air pressure and outlet air velocity to make use of the features of con-di nozzle 412, which increase the kinetic energy of the air flow from subsonic speed exiting air outlet 418 to Mach 1 at the throat of con-di nozzle 412 to supersonic speed through the divergent portion the nozzle. More specifically, the air pressure and outlet air velocity in conjunction with the dimensions and shape of the convergent portion of con-di nozzle 412 are adapted to achieve a choked flow of air at the local speed of sound at the narrow point of con-di nozzle 412 such that the air flow accelerates through an appropriately designed divergent portion of con-di nozzle 412. A turbine generator 414, responsive to a kinetic air flow, is provided to make use of the resulting air flow to generate electricity. In this embodiment, turbine generator 414 comprises a ram air turbine generator. A byproduct is heat energy emanating from air compressor 410 that may be utilized if desired. Alternatively, the desired convergent-divergent shape may be provided by an appropriately designed valve. Alternatively, a motive power means responsive to a gaseous flow may be provided for purposes other than the generation of electricity.

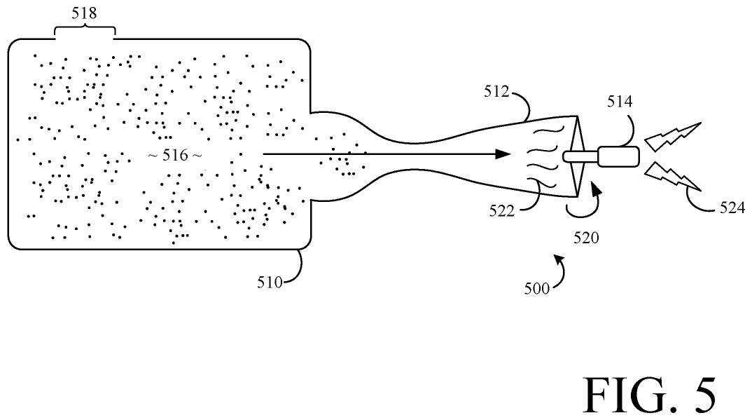

FIG. 5 depicts one embodiment of a system for generating power in accordance with an embodiment of the invention and referenced generally by the numeral 500. FIG. 5 includes a compressor 510 coupled to cog-di nozzle 512. System 500 includes a convergent-divergent (“con-di”) nozzle 512. With reference to FIG. 1 and FIG. 5, nozzle 512 includes an inlet 110, an ingress potion 114, a throat 116, an egress portion 118, and an outlet 112. Inlet 110 has an inlet diameter, throat 116 has a throat diameter, and outlet 112 has an outlet diameter.

The inlet diameter is larger than the throat diameter such that a cross-sectional area of the ingress portion converges from the inlet diameter to the throat diameter to form convergent portion 114 of con-di nozzle 512.

The outlet diameter is larger than the throat diameter such that the cross-sectional area of egress portion 118 diverges from the throat diameter to the outlet diameter to form divergent portion 118 of con-di nozzle 512. The throat diameter (e.g., at location 116) is the smallest diameter of any portion of con-di nozzle 512. Nozzle 512 could be disposed partially or completely within a housing of compressor 510. Intermediate devices or hoses could be used to couple nozzle 512 to compressor 510.

A compressor 510 is coupled to nozzle 512 and adapted to motivate a flow of gas to exit the con-di nozzle, indicated by reference numeral 522. Gas 516 is compressed by compressor 510, which includes an inlet 518 from which to receive air and an outlet (such as outlet 214 in FIG. 2) through which air is passed into nozzle 512. The motivated flow of gas has a constant mass-flow rate. Compressor 510 is adapted to cause the gas to flow through the throat at a gas speed so as to create a choked-flow condition. The gas speed through the throat is a choked flow at the speed of sound (“sonic”), which facilitates the exiting the throat at a speed greater than the speed of sound (“supersonic”).

Turbine 514 is situated to be excited by the flow of gas 522, exiting turbine 514 (indicated by numeral 520), thereby enabling a generation of power 524 from the excitation of turbine 514. Turbine 514 is within a proximity to the outlet of the con-di nozzle such that substantially all of the gas 522 exiting the nozzle outlet interacts with turbine 514. In one embodiment, at least a portion of turbine 514 is disposed within at least a portion of the egress portion 118 of con-di nozzle 512. In one embodiment, turbine 514 includes a generator that generates power in response to the exciting of turbine 514, including in response to a rotational movement of the turbine. The power generated includes a generation of electricity 524.

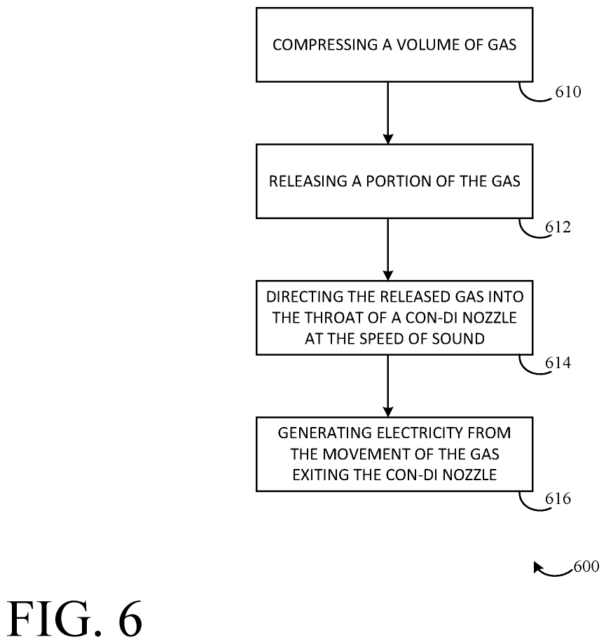

Turning now to FIG. 6, an illustrative method for generating electricity according to an embodiment of the invention is provided and referenced generally by the numeral 600. In this embodiment, a volume of gas is compressed at a step 610. As mentioned, this can be accomplished by way of an air compressor, such as a large, commercial-grade air compressor. At a step 612, at least a portion of the gas is released. For example, the gas is received from the air compressor into an inlet of a con-di nozzle and ultimately through a throat of the con-di nozzle. Although the speed into the con-di nozzle might be subsonic, the speed through the throat is the speed of sound, and the speed of air flow exiting the throat is supersonic. Thus, at a step 614, a flow of gas is directed through a con-di nozzle to a speed greater than the speed of sound (“supersonic”). At a step 616, electricity is generated from the movement of the gas exiting the nozzle. One way of generating such electricity is direct the air exiting the nozzle to flow through the blades of a kinetic turbine generator. The rotation of the generator generates electricity.

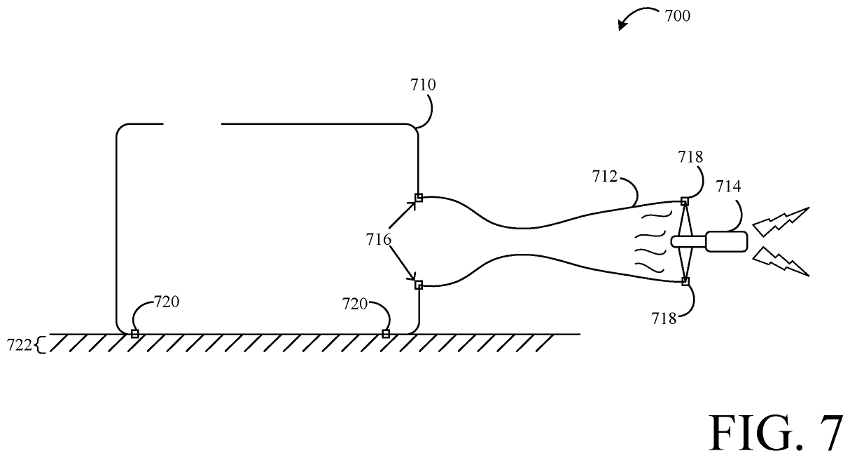

Con-di nozzles have been used to propel spacecraft. But propulsion or other lateral movement of this entire device is not necessary, and in some embodiments, not allowed. Rather the device is primarily meant to remain stationary, with the kinetic energy transferred to the rotational movement of the kinetic turbine for electrical or motive power, to the extent efficiently possible. FIG. 7 illustrates these aspects.

FIG. 7 depicts an embodiment of the invention that is referenced generally by the numeral 700, which includes a compressor 710, con-di nozzle 712, and kinetic turbine 714. Nozzle 712 is coupled to compressor 710 by way of anchors 716. Similarly, turbine 714 includes anchors 718 to prevent translational movement with respect to nozzle 712. And anchors 720 prevent translational movement of the compressor and/or apparatus 700. Alternatively, kinetic turbine 714 could be anchored to ground in similar fashion to compressor 720. The ground is represented by the set of angled lines 722. Reference numerals 716, 718, and 720 could take on a variety of forms, such as a weld, screws, a seal, rivets, etc. The shapes, shown as squares, are not limiting. They are provided for referential, not physically descriptive, purposes.

While principles of embodiments of the invention have been made clear in the above disclosure, those skilled in the art may make modifications in the structure, arrangement, portions and components of the invention without departing from those principles. The description and drawings are interpreted as illustrative and not in a limiting sense except that the invention is given a scope commensurate with the included (or subsequently included) claims.

The terminology used herein is for the purpose of describing particular embodiments only and is not intended to be limiting of the invention. As used herein, the term “and/or” includes any and all combinations of one or more of the associated listed items. As used herein, the singular forms “a”, “an”, and “the” are intended to include plural forms as well as singular forms, unless the context clearly indicates otherwise. It will be further understood that the terms “comprises” and/or “comprising”, when used herein, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. One or more embodiments of the invention were described using a number of techniques and steps. Each embodiment has benefits and each can also be used in conjunction with one or more, or in some cases all, of the other disclosed techniques/embodiments. Accordingly, for the sake of readability, this description has refrained from repeating every possible combination of the individual steps in an unnecessary fashion. Nevertheless, the specification and claims should be read with the understanding that such combinations are entirely within the scope of the claims if so claimed.

What is claimed is:

1. A system for generating power comprising:
a convergent-divergent (“con-di”) nozzle,
wherein the nozzle includes an inlet, an ingress potion, a throat, an egress portion, and an outlet,
wherein the inlet has an inlet diameter, the throat has a throat diameter, and the outlet has an outlet diameter,
wherein the inlet diameter is larger than the throat diameter such that a cross-sectional area of the ingress portion converges from the inlet diameter to the throat diameter to form a convergent portion of the con-di nozzle;
wherein the outlet diameter is larger than the throat diameter such that the cross-sectional area of the egress portion diverges from the throat diameter to the outlet diameter to form a divergent portion of the con-di nozzle;
a compressor coupled to the con-di nozzle and adapted to motivate a flow of gas to exit the con-di nozzle;
a kinetic turbine situated to be excited by the flow of the gas exiting the nozzle, thereby enabling a generation of power from the excitation of the turbine.

2. The system of claim 1, wherein the throat diameter is the smallest diameter of any portion of the con-di nozzle.

3. The system of claim 2, wherein the motivated flow of gas is characterized by a mass flow rate, and wherein the mass flow rate is substantially constant.

4. The system of claim 3, wherein the compressor is adapted to cause the gas to flow through the throat at a gas speed so as to create a choked-flow condition.

5. The system of claim 4, wherein the gas speed is a choked flow at the local speed of sound (that is “sonic”), thereby facilitating the gas to exit the throat at a speed greater than the speed of sound (“supersonic”).

6. The system of claim 4, wherein the turbine is within a proximity to the outlet of the con-di nozzle such that substantially all of the gas exiting the outlet interacts with the turbine.

7. The system of claim 6, wherein the turbine includes one of more blades, and wherein the gas interacts with the blades at supersonic speeds.

8. The system of claim 7, wherein each of said blades is less than two meters long.

9. The system of claim 7, wherein each of said blades is less than one meter long.

10. The system of claim 6, wherein the turbine is disposed within a portion of the egress portion of the con-di nozzle.

11. The system of claim 6, wherein the turbine includes a generator that generates power in response the exciting of the turbine, including in response to a rotational movement of the turbine.

12. The system of claim 11, wherein the power generated includes a generation of electricity.

13. The system of claim 1, wherein the system is anchored to the ground to prevent translational movement of the system.

14. A method of generating power, comprising:
directing a flow of gas through a convergent-divergent (“con-di”) nozzle to a speed greater than the speed of sound (“supersonic”);
causing a turbine to rotate in response to the flow of gas, thereby generating power from the rotating turbine.

15. The method of claim 14, wherein the flow of gas is created from a release of a pressurization of the gas.

16. The method of claim 15, wherein the pressurization of the gas is caused by a gas compressor.

17. The method of claim 15, wherein the flow of gas through the con-di nozzle has a constant mass-flow rate, thereby enabling a choked-flow condition and causing the gas to exit a throat of the con-di nozzle at the supersonic speed.

18. The method of claim 14, wherein the power is generated by a generator coupled to the turbine.

19. The method of claim 15, wherein the said generator is integrated with said turbine.

20. A power-generating system comprising:
an air compressor coupled to a convergent-divergent (“con-di”) nozzle and adapted to introduce an ingress flow of air from the compressor into the nozzle; and
a kinetic turbine coupled to the con-di nozzle and situated to be excited by an egress flow of gas exiting the nozzle, thereby enabling a generation of power from the excitation of the turbine.
